(19) United States
(12) Patent Application Publication
(10) Pub. No.: US 2009/0057943 A1
(43) Pub. Date: Mar. 5, 2009

(54) SOLUTION CASTING PROCESS AND APPARATUS

(75) Inventors: Takuro Nishimura, Minami-ashigara-shi (JP); Hidekazu Yamazaki, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/202,836

(22) Filed: Sep. 2, 2008

(30) Foreign Application Priority Data
Sep. 5, 2007 (JP) 2007-229705

(51) Int. Cl. B29C 39/14

(52) U.S. Cl. 264/169; 425/226

(57) ABSTRACT

In a solution casting apparatus, polymer dope containing cellulose ester and solvent is cast to form cellulose ester film continuously. A filtration device has a precoat of a filter aid deposited on a filter screen, for filtering polymer dope to be cast. A washer washes the filtration device after discontinuing supply of the polymer dope to the filtration device. A filter regenerating device deposits a precoat of the filter aid in the washed filtration device by use of precoat solution containing the filter aid, the polymer dope and solvent. A drain line drains the precoat solution from the filtration device after depositing the precoat. The filtration device is charged with solvent saturated gas upon draining. A valve mechanism changes over plural filtration devices, to manage the filtration device among the filtration devices in the washer, the filter regenerating device and the drain line.

### BACKGROUND OF THE INVENTION

1. Field of the Invention

The present invention relates to a solution casting process and apparatus. More particularly, the present invention relates to a solution casting process and apparatus in which solution is filtered before casting and efficiency of filtration can be kept by managing a flow line of the filtration.

2. Description Related to the Prior Art

Polymer film, such as cellulose ester film, is used in a display panel or other optical devices such as liquid crystal display panel, in a form of a protection film of a polarizer plate and a wide viewing-angle film. Methods of producing the polymer film for the optical use include a melt casting process and a solution casting process. In the solution casting, dope as a solution of polymer in solvent is cast on a moving support to form cast film, which is stripped from the support and dried to obtain the polymer film. There is no problem of damage with heat which may occur in the melt casting. The solution casting is very suitable in producing the polymer film in which high transparency and high optical performance are important.

Impurity is present in the dope as insoluble material in the solvent. As an origin, impurity may be contained in raw material of the dope, or may be dust or unwanted particles mixed in the course of the preparation. When the dope with impurity is used, the impurity precipitates on the support, and causes difficulties in stripping the cast film from the support. The polymer film may have low quality due to impurity in the polymer film may scatter light in the optical use. It is necessary to eliminate the impurity from the dope before casting.

In general, a filter of a porous form is used in the solution casting to filter the dope before casting for the purpose of removing impurity. Examples of the filter include filter paper, metal filter, filter fabric and the like. However, pores in the filter are likely to clog according to long time after the start of the filtration. Efficiency in filtration may drop due to an increase in the pressure of the filtration or decrease in a flow rate of the filtration. To use the metal filter, the metal filter is backwashed by a flow of washing liquid in a direction reverse to the filtration. The washing liquid is circulated to wash and regenerate the metal filter. However, there is no known method of raising the efficiency of the filtration because those available methods are only for temporary adjustment of the filtration.

It is still difficult to remove impurity as insoluble material if only the filter is used, such as filter paper, the metal filter and filter fabric. U.S.P. No. 2004/023051 (corresponding to JP-A 2004-107629) discloses the filtration in which filter aid is used with the filter to remove impurity of the insoluble characteristic. For example, the filter aid is particles or powder of silicon dioxide (SiO₂) with a chemically inert characteristic. The filter aid is randomly deposited on a filter screen or filter septum, such as mesh of metal. The impurity is adsorbed on the filter aid to grow as filter cake, by passage of the dope through the filter with the deposit layer no matter how insoluble the impurity is. So a highly clarified filtrate can be obtained. The filter aid is further effective in suppressing the clogging of the filter, to raise the productivity by use of the filtrated dope.

To raise the speed of the production requires rapid development of the self-supporting property of the cast film upon casting the dope. Although high density of the dope is preferable, a loss in the pressure may be considerably great if the filter aid is used in filtering the dope with high viscosity. Suitable use of the filter aid is important in compensating for the loss in the pressure with particles of a sufficiently great diameter to keep the shape with pores.

In the filtration with the filter aid, operation of precoat forming is required, in which the filter aid of a sufficient amount is deposited on the filter screen or mesh of metal. It is preferable in the precoat forming or filter regeneration to use the same solution or dope as the filtration, because of simplicity and good efficiency without exchange of solutions or fluids. However, there is a problem in highness of the loss in the pressure and limit of a sufficient flow rate due to high viscosity, typically in case of the dope for use in the solution casting. As the flow rate cannot be very high, time for the precoat forming or filter regeneration must be considerably long, so efficiency in the filtration will be low. It is conceivable to use only solvent for the dope as precoat solution in place of the dope to be filtered. However, a problem arises in excessive smallness in the viscosity of the precoat solution. Settling of the filter aid may be considerable. This creates non-uniformity in the distribution of density in the filter aid in the filter housing. Precoat in a uniform manner cannot be formed easily.

It is also conceivable to use diluted dope produced by dilution of the polymer dope. However, the diluted dope has a characteristic of evaporating rapidly. An unwanted skin layer is likely to occur if the diluted dope is not handled in a suitable manner of processing. Pores in the surface of the filter aid will be clogged to cause failure in effective filtration of the dope.

### SUMMARY OF THE INVENTION

In view of the foregoing problems, an object of the present invention is to provide a solution casting process and apparatus in which solution is filtered before casting and efficiency of filtration can be kept by managing a flow line of the filtration.

In order to achieve the above and other objects and advantages of this invention, a solution casting process of casting polymer dope containing polymer and solvent to form polymer film continuously is provided. There is a filtering step of filtering the polymer dope to be cast in a filtration device having a precoat of a filter aid deposited on a filter screen. In a washing step, the filtration device is washed after discontinuing supply of the polymer dope to the filtration device. In a filter regenerating step, a precoat of the filter aid is deposited in the washed filtration device by use of precoat solution containing the filter aid, the polymer dope and solvent. In a draining step, the precoat solution is drained from the filtration device after depositing the precoat, wherein the filtration device is charged with solvent gas upon draining. In a changeover step, plural filtration devices are changed over to subject the filtration device among the filtration devices to the washing step, the filter regenerating step and the draining step.

In the washing step, washing is carried out after the filter aid is drained in a form of slurry.

In the changeover step, efficiency information of filtration of the filtration device is monitored, and when the efficiency information becomes lower than reference efficiency information, the filtration device is washed in the washing step.

Viscosity of the precoat solution is 0.5-200 mPa·s.

In the filter regenerating step, a terminal settling velocity of the filter aid is controlled in a range of 10⁻⁴ to 1 cm/sec.

In the filter regenerating step, a flow rate of the precoat solution relative to the filter screen is 3.3-80 liters/(m²·min).

A flow rate of draining the precoat solution in the draining step is 1×10⁻³ m/sec or less relative to a surface of the precoat.

The filter aid is silicon dioxide with an average particle diameter in a range of 20-50 microns, the polymer is cellulose acylate, density of the filter aid in the precoat solution is 0.25-5.0 wt. %, and density of cellulose in the precoat solution is 0.5-5.0 wt. %.

The plural filtration devices are connected in parallel, and in the changeover step, the filtration devices are cyclically changed over to continue the filtering step.

A solution casting apparatus for casting polymer dope containing polymer and solvent to form polymer film continuously is provided. A filtration device has a precoat of a filter aid deposited on a filter screen, for filtering the polymer dope to be cast. A washer washes the filtration device after discontinuing supply of the polymer dope to the filtration device. A filter regenerating device deposits a precoat of the filter aid in the washed filtration device by use of precoat solution containing the filter aid, the polymer dope and solvent. A drain line drains the precoat solution from the filtration device after depositing the precoat, wherein the filtration device is charged with solvent gas upon draining. A valve mechanism changes over plural filtration devices, to manage the filtration device among the filtration devices with the washer, the filter regenerating device and the drain line.

The washer washes after the filter aid is drained in a form of slurry.

Furthermore, a controller monitors efficiency information of filtration of the filtration device, and when the efficiency information becomes lower than reference efficiency information, actuates the valve mechanism to wash the filtration device with the washer.

The filter regenerating device includes a precoat solution reservoir for dispersing the filter aid in a diluted polymer dope obtained by dilution of the polymer dope with the solvent, to obtain the precoat solution.

The filter regenerating device includes a circulating reservoir for storing the precoat solution. The drain line returns the precoat solution to the circulating reservoir from the filtration device. Furthermore, a gas flow line supplies the filtration device with solvent saturated gas of the solvent from the circulating reservoir. A flow rate of draining the precoat solution in the drain line is 1×10⁻³ m/sec or less relative to a surface of the precoat.

The washer includes a washing tank for reserving washing liquid. A wash line dispenses the washing liquid to the filtration device to pass the washing liquid through the filtration device. A return line dispenses slurry obtained by passage of the washing liquid in the filtration device to the washing tank for circulation. A separator separates the slurry from the washing tank into solution and a solid content.

Furthermore, a polymer dope feeding device supplies the polymer dope. The plural filtration devices include first and second filtration devices. The valve mechanism includes a first valve for selectively connecting the first and second filtration devices with the polymer dope feeding device. A second valve selectively connects the first and second filtration devices with the washer. A third valve selectively connects the first and second filtration devices with the filter regenerating device. A controller controls the first, second and third valves, wherein the controller, when the first filtration device is connected with the polymer dope feeding device, connects the second filtration device with the washer at first, and then connects the second filtration device with the filter regenerating device, and when the second filtration device is connected with the polymer dope feeding device, connects the first filtration device with the washer at first, and then connects the first filtration device with the filter regenerating device.

Consequently, efficiency of filtration can be kept by managing a flow line of the filtration, because the filter regeneration can be carried out in a reliable manner by use of solvent and solvent gas in the precoat forming.

### BRIEF DESCRIPTION OF THE DRAWINGS

The above objects and advantages of the present invention will become more apparent from the following detailed description when read in connection with the accompanying drawings, in which:

FIG. 1 is a flow diagram schematically illustrating a solution casting apparatus;

FIG. 2 is an explanatory view illustrating a filter screen and a precoat in a filtration device;

FIG. 3 is a flow diagram schematically illustrating a filter regenerating device;

FIG. 4 is a flow diagram schematically illustrating a washer in which washing liquid is circulated;

FIG. 4A is a timing chart of sequences of operation of valves V1-V7;

FIG. 5 is a flow diagram schematically illustrating a drier;

FIG. 6 is a graph illustrating a relationship between a total of a filter aid the strength of the precoat;

FIG. 7 is an explanatory view in a front elevation, illustrating a solution casting subsystem.

### DETAILED DESCRIPTION OF THE PREFERRED EMBODIMENT(S) OF THE PRESENT INVENTION

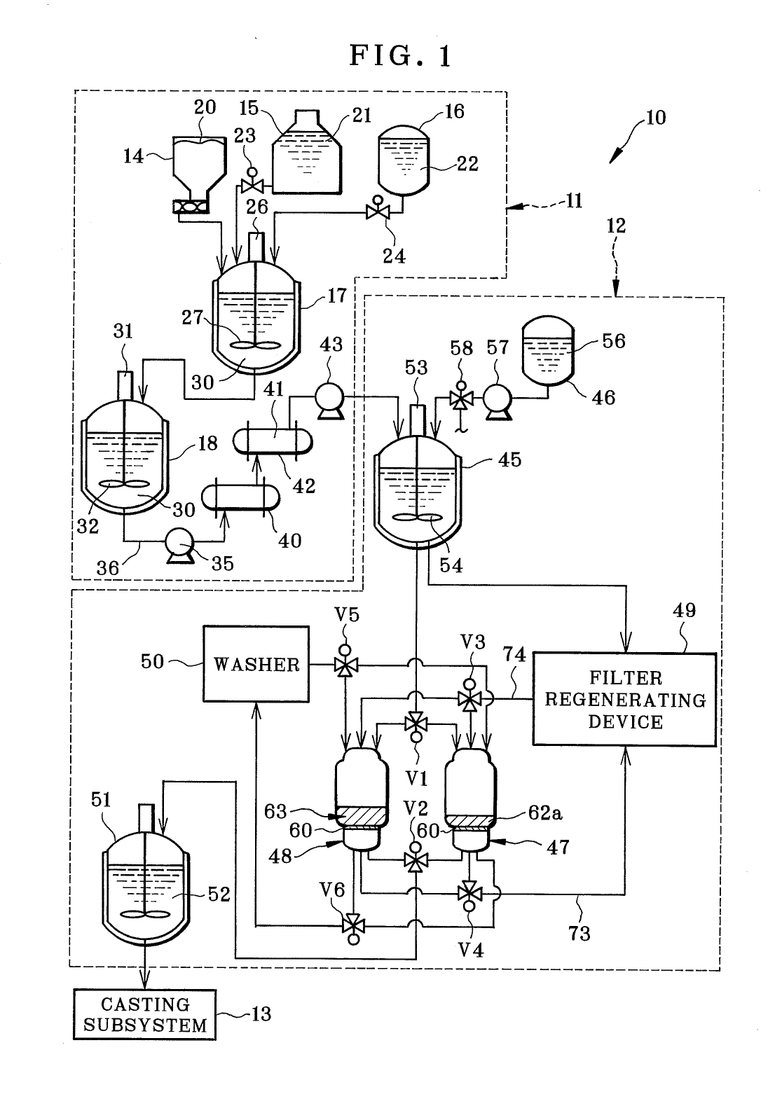

In FIG. 1, a solution casting system or apparatus 10 includes a polymer dope feeding device 11, a filtration subsystem or apparatus 12, and a solution casting subsystem or apparatus 13.

The polymer dope feeding device 11 includes a flow meter 14, a solvent tank 15, an additive dispenser 16, a dissolving tank 17 and a storage tank 18. Polymer 20 is measured by the flow meter 14, and is supplied to the dissolving tank 17. Solvent 21 is contained in the solvent tank 15. When a control valve 23 is actuated for opening and closing, a supply amount of the solvent 21 is adjusted. Additives 22 are contained in the additive dispenser 16. When a control valve 24 is actuated for opening and closing, a supply amount of the additives 22 is adjusted.

Examples of the polymer 20 are not limited and can be such suitable for the solution casting method. Polymer film with high transparency and high optical performance can be obtained by use of cellulose acylate, and can be effectively used as protective film for a polarization plate, optical compensatory film, and the like. Polymer films of cellulose acetates having an average of the acetylation degree of 57.5-62.5% are desirably employed in the present invention as a transparent substrate. The term of the acetylation degree means an amount of acetic acid bonding to cellulose per unit weight of cellulose. This can be measured according to the measurement and calculation of acetylation degree of ASTM: D-817-91 (tests of cellulose acetates and the like). In the embodiment, cellulose triacetate of a particle shape is used. In view of compatibility with the solvent, 90 wt. % or more of the polymer of the particle shape preferably has a particle diameter of 0.1-4 mm, and desirably has a particle diameter of 1-4 mm.

The solvent 21 as raw material of dope is preferably halogenated hydrocarbons, esters, ketones, ethers, alcohols, and the like. Those can be selected according to compatibility with the polymer for use. The solvent 21 may be a single compound or may be a mixed solvent containing plural compounds. Examples of solvents include:

halogenated hydrocarbons, such as dichloromethane;

esters, such as methyl acetate, methyl formate, ethyl acetate, amyl acetate, and butyl acetate;

ketones, such as acetone, methyl ethyl ketone, and cyclohexanone;

ethers, such as dioxane, dioxolane, tetrahydrofuran, diethyl ether, and methyl t-butyl ether;

alcohols, such as methanol and ethanol.

Materials for the additives 22 can be selected in accordance with desired characteristics of the cellulose ester film. Examples of the materials include plasticizers, ultraviolet (UV) absorbers, stripping accelerators, fluorine-containing surface active agents, and other additives. Specifically preferable plasticizers are as follows:

phosphate esters, such as triphenyl phosphate (TPP), tricresyl phosphate, cresyl diphenyl phosphate, octyl diphenyl phosphate, diphenyl biphenyl phosphate (BDP), trioctyl phosphate, and tributyl phosphate;

phthalate esters, such as diethyl phthalate, dimethoxy ethyl phthalate, dimethyl phthalate, and dioctyl phthalate;

glycolate esters, such as triacetin, tributylin, butyl phthalyl butyl glycolate, ethyl phthalyl ethyl glycolate, methyl phthalyl ethyl glycolate, and butyl phthalyl butyl glycolate.

In particular, a preferable example of plasticizer is triphenyl phosphate (TPP) for use in cellulose ester film. Note that known plasticizers other than those can be used. Examples of UV absorbers are oxybenzophenone compounds, benzotriazol compounds, salicylate ester compounds, benzophenone compounds, cyanoacrylate compounds, and nickel complex salt compounds. In particular, benzotriazol compounds and benzophenone compounds are preferable.

A stirring blade 27 is disposed in the dissolving tank 17. A stirring motor 26 rotates the stirring blade 27. The stirring blade 27 stirs the polymer 20, the solvent 21 and the additives 22 in the solvent tank 15 by rotation. A first solution 30 or premix solution of those components is obtained by the stir. The first solution 30 has the polymer 20 which has not been completely dissolved yet.

The first solution 30 in the dissolving tank 17 is supplied and stored in the storage tank 18. Thus, the dissolving tank 17 becomes empty. Repeated preparation of the first solution 30 is possible as continuous batch process. The storage tank 18 also includes a stirring blade 32 and a stirring motor 31 for rotating the same. The first solution 30 is stirred by rotation of the stirring blade 32 and becomes uniform.

A flow line 36 and a pump 35 are connected with the storage tank 18. The first solution 30 is supplied to a heater 40 from the storage tank 18 through the flow line 36. An in-line mixer is used in the heater 40, such as a multi-tube heat exchanger and a static type of mixer. The heater 40 heats the first solution 30. Temperature of heating in the heater 40 is preferably 50-120 deg. C. Time of heating in the heater 40 is preferably 5-30 minutes. Solutes including the polymer 20 in the first solution 30 or premix solution are dissolved completely without modification, so that polymer dope 41 is obtained. The polymer dope 41 is so prepared initially that density of the solid content of cellulose ester is in a range of 14-24 wt. %. The polymer dope 41, if desired, can be condensed according to flash condensation or the like.

A cooler 42 is supplied with the polymer dope 41 heated by the heater 40. The cooler 42 cools the polymer dope 41 down to the temperature equal to or lower than the boiling point of a main component of the solvent of the polymer dope 41. A pump 43 is connected with the cooler 42. A body feed tank 45 of the filtration subsystem 12 is supplied by the pump 43 with the polymer dope 41 being cooled.

The filtration subsystem 12 includes the body feed tank 45, a filter aid tank 46, a first filtration device 47, a second filtration device 48, a filter regenerating device 49 as precoat solution circulator or as precoat forming device, a washer 50 as washing liquid circulator, and a casting dope tank 51. In the filtration subsystem 12, a filter aid 44 is used for filtering the polymer dope 41, so that casting dope 52 is obtained as filtrate. Valves V1-V7 reside in flow lines between the body feed tank 45, the filter aid tank 46 and the casting dope tank 51 and the filtration devices 47 and 48, and are operated to changeover, and washing of the filtration devices 47 and 48, and precoat forming. Thus, the polymer dope 41 is filtered continuously to obtain the casting dope 52. Note that the valves V1-V7 in the filtration subsystem 12 may be modified in a manner different from the embodiment. Also, additional pumps (not shown) are included in the filtration subsystem 12 for various purposes.

Filter aid solution 56 is stored in the filter aid tank 46. A pump 57 and a valve 58 cooperate to supply the filter aid solution 56 to the body feed tank 45. The filter aid solution 56 is constituted by a solvent and the filter aid 44 dispersed in the solvent, and is used for raising efficiency in capturing impurity in the polymer dope 41. Examples of the filter aid 44 are not limited, but can be diatomaceous earth (SiO₂) of a grain shape, derivatives of cellulose compounds, and the like. Note that the solvent should preferably include at least one solvent component the same as that contained in the polymer dope 41, in consideration of compatibility with the polymer dope. An amount of the filter aid 44 added to the polymer dope 41 is 0.01-10 wt. %, preferably 0.05-5 wt. %, and desirably 0.1-2 wt. %. Specifics of the filter aid 44 are described in U.S.P. No. 2004/023051 (corresponding to JP-A 2004-107629), including compounds, compositions, average particle diameter, volume density and the like.

The body feed tank 45 is supplied with the polymer dope 41 and the filter aid solution 56. A stirring blade 54 is disposed in the body feed tank 45. A stirring motor 53 rotates the stirring blade 54. The stirring blade 54 stirs the polymer dope 41 by rotation to disperse the filter aid solution 56 of a predetermined ratio in a uniform manner.

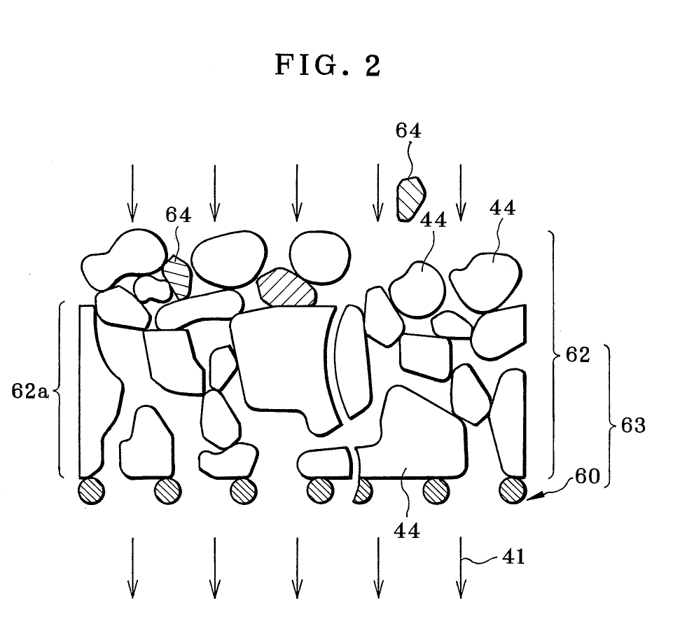

For filtration with the filter aid in the first filtration device 47, the valves V1-V6 are actuated to connect the body feed tank 45 with the first filtration device 47 by changeover. Then the polymer dope 41 with the filter aid 44 is supplied to the first filtration device 47. In FIG. 2, the first filtration device 47 contains a filter 63, which includes a filter screen 60 or filter septum and a deposit layer 62 of the filter aid 44 formed on the filter screen 60 in a randomly distributed manner.

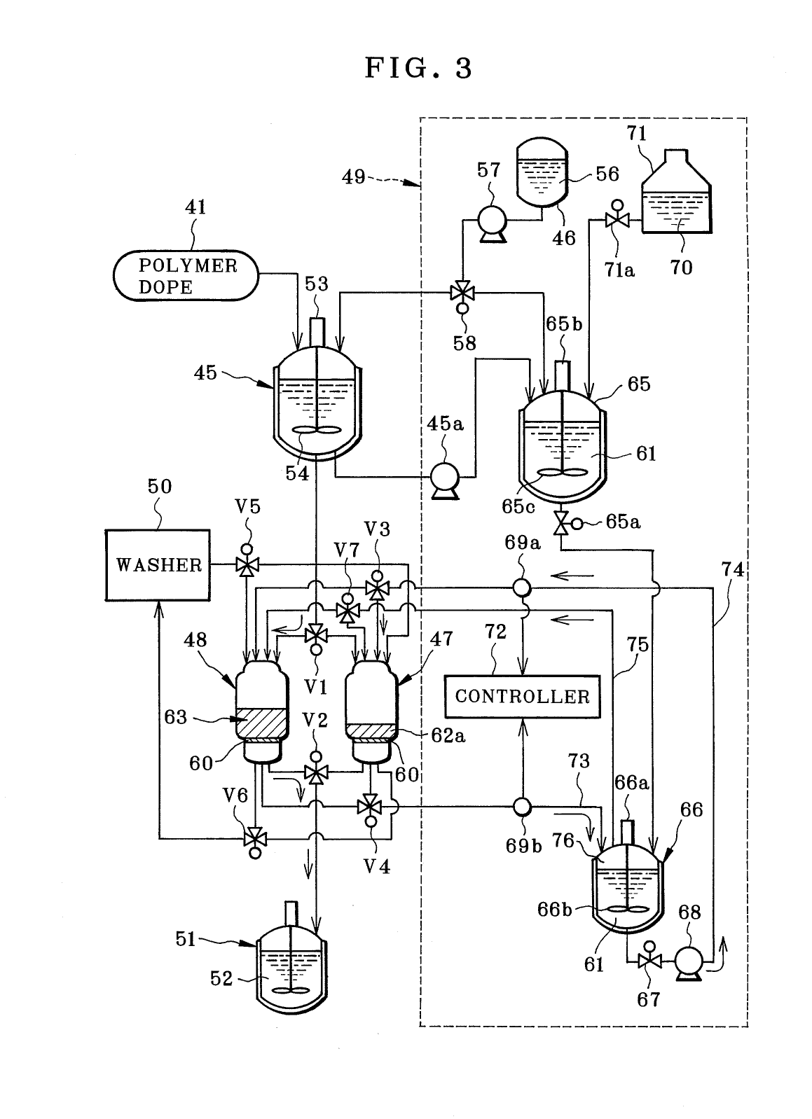

After the first filtration device 47 is washed, only the filter screen 60 remains by removal of the filter aid. As the filter screen 60 itself cannot operate for filtration effectively, the deposit layer 62 is formed on the filter screen 60 at a predetermined thickness. A precoat 62a is a term for an initial phase of the deposit layer 62. To form this, precoat solution 61 of FIG. 3 is circulated in the first filtration device 47 by the filter regenerating device 49 for a predetermined time.

In FIG. 2, only the polymer dope 41 passes the filter 63 in the first filtration device 47. The filter aid 44 remains and deposits on the filter 63 randomly to form the deposit layer 62. Impurity 64 in the polymer dope 41 is adsorbed and collected by the filter aid 44 by passage through the filter 63 including the filter screen 60. Also, numerous pores in the deposit layer 62 capture particles of impurity with a comparatively large size. It is possible by passage through the filter 63 to obtain filtrate from the polymer dope 41 with high clarity, because filter cake is removed by filtration inclusive of the impurity 64 and insoluble material. The filtrate is the casting dope 52, which is supplied to the solution casting subsystem 13 to produce the cellulose ester film with high quality without impurity.

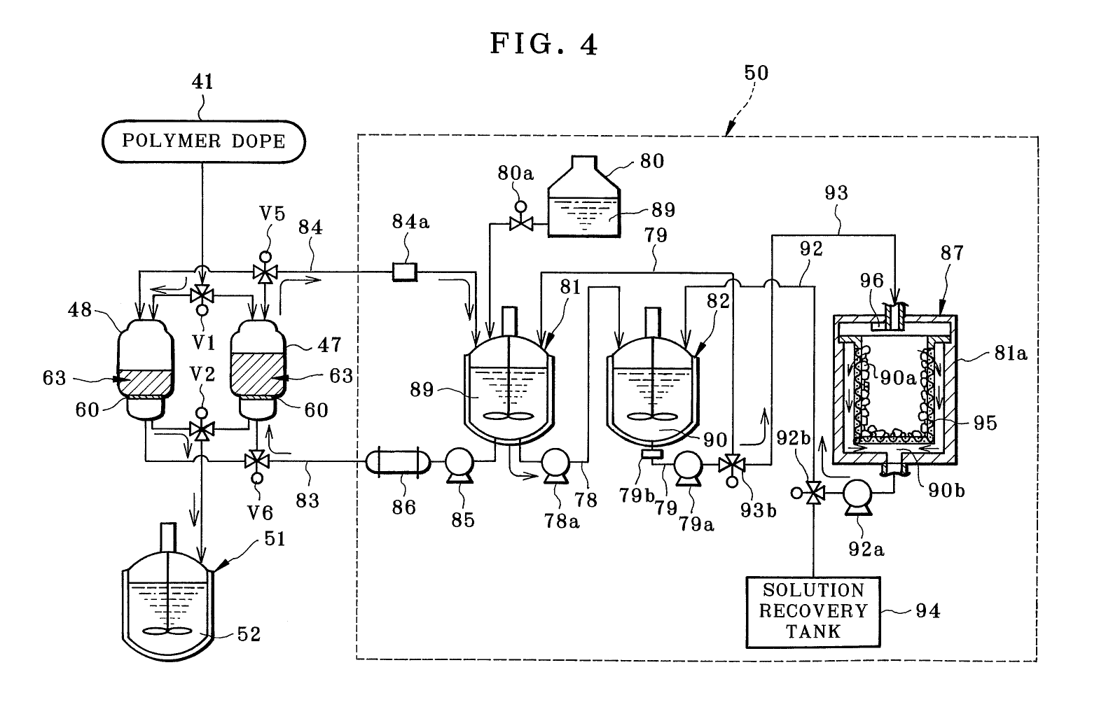

The second filtration device 48 is also constituted in a similar manner to the first filtration device 47. During the filtration in the first filtration device 47, the second filtration device 48 is washed and then regenerated by filter regeneration of precoat forming. The alternate sequence of the filtration and the washing followed by the filter regeneration makes it possible to filter the dope continuously with the filtration devices 47 and 48. Note that the number of the filtration devices 47 and 48 may not be two, but can be three or more. During the filtration in the first filtration device 47, pressure of the filtration is monitored. When the pressure becomes equal to or higher than a reference pressure, then the filtration is changed over to the second filtration device 48 for the continuous filtration. At the same time, the first filtration device 47 is changed over for washing, and washed by the washer 50 removing the filter aid 44 and filter cake as slurry of FIG. 4. After the washing, the filter regenerating device 49 circulates the precoat solution 61 through the first filtration device 47, to form the precoat 62a as illustrated in FIG. 2. After the precoat 62a is formed, the filtration device 47 stands by for succeeding step. Note that the filtration devices 47 and 48 may be arranged in series with one another in place of the arrangement in parallel with one another. It is possible to obtain high efficiency in collection of filter cake by the filtration.

A precoat forming step and a washing step for the filtration devices 47 and 48 are described now. In FIG. 3, the filter regenerating device 49 includes a precoat solution reservoir 65, a valve 65a, a circulating reservoir 66 as fluid exchanger, a valve 67, a pump 68, turbidity meters 69a and 69b, and a controller 72. A pump 45a causes the polymer dope 41 with the filter aid 44 to flow from the body feed tank 45 to the precoat solution reservoir 65. A solvent tank 71 is connected with the precoat solution reservoir 65. Diluent solvent 70 is supplied from the solvent tank 71 to the precoat solution reservoir 65 through a valve 71a at a predetermined amount. The precoat solution 61 is formed, in which the polymer dope 41 with the filter aid 44 is diluted at a constant density. The precoat solution reservoir 65 includes a stirring motor 65b and a stirring blade 65c, which is caused by the stirring motor 65b to rotate to stir the precoat solution 61 uniformly.

Note that the diluent solvent 70 is preferably at least one solvent component included in the solvent components constituting the dope solvent, and desirably all the solvent components constituting the dope solvent.

In the precoat solution 61, density of solid content of the cellulose ester is 0.25-7 wt. %. An added amount of the filter aid 44 is 0.01-10 wt. %. Preferably, in the precoat solution 61, density of solid content of the cellulose ester is 0.5-5.0 wt. %. An amount of the filter aid 44 is 0.25-5.0 wt. %. Desirably, in the precoat solution 61, density of solid content of the cellulose ester is 2-4 wt. %. An amount of the filter aid 44 is 0.7-2 wt. %. Should the density of the solid content be lower than 0.25 wt. % or should the amount of the additives be lower than 0.01 wt. %, then the viscosity will be too low so that no uniformity of the precoat can be ensured due to the increase in the settling of the particles. Should the density of the solid content be higher than 7 wt. % or should the amount of the additives be higher than 10 wt. %, then the viscosity will be too high so that no high flow rate can be obtained due to the great loss in the pressure. The filter aid 44 is particles of SiO₂ with an average diameter of 10-70 microns, and preferably with an average diameter of 20-50 microns. The filter screen 60 of metal is 350 mesh of SUS steel.

In FIG. 3, the filter regeneration is illustrated. At first, a communication flow line 74 causes the precoat solution 61 to flow from the circulating reservoir 66 to the first filtration device 47, to pass the filter screen 60. Then a drain line 73 returns the precoat solution 61 to the circulating reservoir 66. On the filter screen 60, the filter aid 44 in the precoat solution 61 becomes deposited gradually as illustrated in FIG. 2. When a thickness of the deposit layer 62 becomes as great as a predetermined value, the filter regeneration is terminated as sufficient layer growth of the precoat 62a. Note that in FIG. 3, the precoat solution reservoir 65 and the circulating reservoir 66 are used. However, it is possible to omit the circulating reservoir 66. The solution can be prepared and stored in the precoat solution reservoir 65 to circulate the precoat solution 61.

A flow rate of the precoat solution in the filter regeneration relative to the filter screen 60 is 3.3-80 liters/(m²·min), and preferably 20-60 liters/(m²·min). If the flow rate is higher than 80 liters/(m²·min), the deposit layer 62 cannot be formed on the filter screen 60. If the flow rate is lower than 3.3 liters/(m²·min), the precoat 62a cannot be sufficiently firm.

In the precoat forming, the terminal settling velocity of the filter aid is controlled and set in a range of 10⁻⁴ to 1 cm/sec. The terminal settling velocity is preferably in a range of 10⁻³ to 10⁻² cm/sec. To control the terminal settling velocity, the viscosity of the solution of the filter aid, and the particle diameter of the filter aid are changed. Should the terminal settling velocity be lower than 10⁻⁴ cm/sec, the loss in the pressure is excessively great so that no high flow rate can be obtain. Should the terminal settling velocity be higher than 1 cm/sec, no uniform precoat can be formed.

The density of the filter aid 44 in the precoat solution is 0.01-10.0 wt. %, and preferably 0.1-2.0 wt. %. Should the density of the filter aid 44 be higher than 6.0 wt. %, no uniform precoat can be formed due to hindered settling. Should the density of the filter aid 44 be lower than 0.1 wt. %, excessively long time is required for forming the precoat to lower the efficiency in the filter regeneration.

It is unacceptable to open the first filtration device 47 to check the thickness of the precoat 62a, because manual operation is complicated, and slug may be formed on the surface of the precoat 62a due to its contact with air. Consequently, the communication flow line 74 is provided with the turbidity meter 69a between the outlet of the circulating reservoir 66 and the inlet of the first filtration device 47. The drain line 73 as fluid exchanger is provided with the turbidity meter 69b between the circulating reservoir 66 and the first filtration device 47. The controller 72 monitors the outputs of the turbidity meters 69a and 69b, and checks whether layer growth of the precoat 62a is sufficient. To be precise, forming of the precoat 62a causes capture of most of the filter aid 44 in the precoat solution with the filter 63 because of the stabilized performance of filtration. Thus, the amount of the filter aid 44 in the precoat solution 61 remarkably decreases at the outlet of the first filtration device 47. The decrease in the amount of the filter aid 44 is monitored by the controller 72 with the turbidity meters 69a and 69b. When their output level becomes equal to or lower than a predetermined level, the layer growth of the precoat 62a is detected sufficient. After the detection, the system operates to start a sequence of drainage of the precoat solution. Note that only the turbidity meter 69a may be used to detect the layer growth of the precoat 62a instead of the combination of the turbidity meters 69a and 69b. However, the use of the turbidity meter 69b is effective in ensured detection of the layer growth of the precoat 62a according to the turbidity of the solution of the first filtration device 47 on the sides of the inlet and outlet.

Examples of the turbidity meters 69a and 69b are not limited, and can have a structure for detecting the amount of the filter aid 44 in the precoat solution 61, such as an absorbance measuring type, laser scattering turbidity meter, and the like.

The total of the filter aid amount in the precoat solution in the precoat forming step is predetermined according to a relationship between the precoat and the filter aid amount. To be precise, a sufficient strength of the precoat and the filter aid amount are experimentally obtained. When the precoat is formed with the predetermined amount of the filter aid, it is estimated to obtain the sufficient strength. It is preferable in view of safety to prescribe the filter aid amount of the circulation higher than an experimentally obtained value by an amount which may be between a lower limit equal to 1-10% and an upper limit equal to 10-20%. When the output of the turbidity meter becomes equal to or lower than a tolerable value to obtain clarified solution, it is found that most of the filter aid has been used for forming the precoat. The layer growth of the precoat with sufficient strength can be determined.

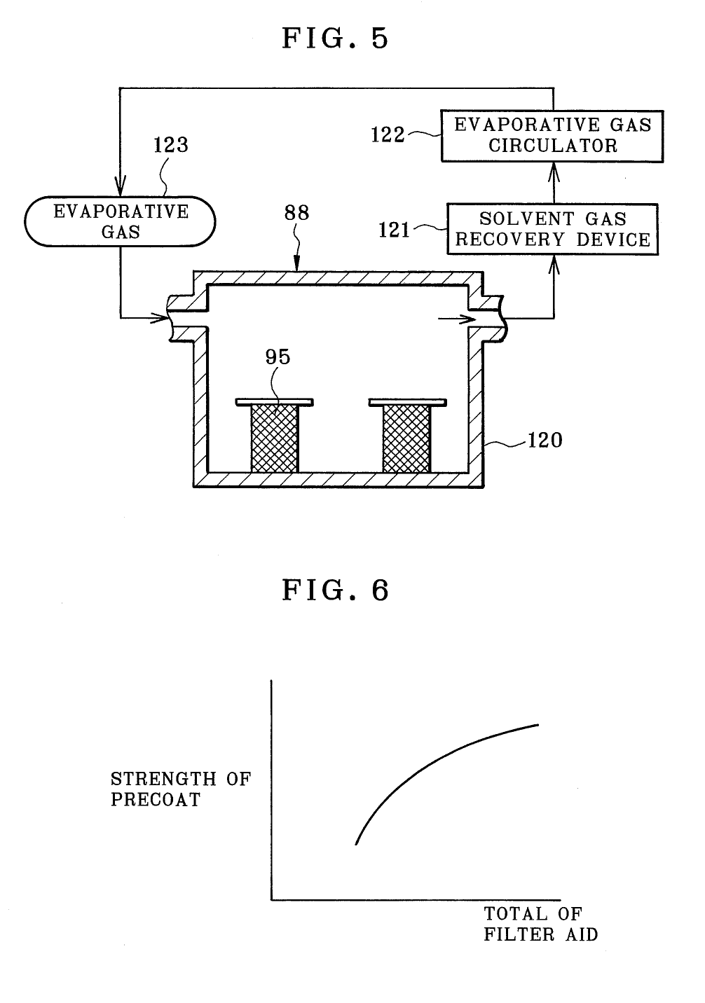

FIG. 6 is a graph of a relationship between the total of the filter aid in the precoat solution and the thickness and strength of the precoat. The thickness increases according to the increase in the total of the filter aid. Thus, predetermined strength can be obtained.

After sufficient layer growth of the precoat 62a is detected, the precoat solution 61 is drained from the first filtration device 47 by gravity. The condition of the drainage only according to the gravity is a not very strict condition with a lower speed of drainage in comparison with forced drainage in pressure of dry air, dry gaseous nitrogen or the like. No skin layer will occur on the surface of the deposit layer 62. A valve V7 resides in a gas flow line 75 as fluid exchanger between the circulating reservoir 66 and the first filtration device 47. When the valve V7 is set open in the drainage of the precoat solution 61 with its weight, solvent saturated gas 76 is filled in the first filtration device 47 by a flow from the circulating reservoir 66. The substitution of the inside of the first filtration device 47 is carried out with the solvent saturated gas 76. Thus, a succeeding step of filtration can be stable without slug formation on the deposit layer 62 in drying of the solvent, and without a skin layer caused by the slug formation in a large area.

The washing step is described now. When the pressure of the filtration becomes considerably high in any one of the filtration devices 47 and 48 owing to the increase in the thickness of the deposit layer 62, the filtration devices 47 and 48 are changed over. For example, the pressure of the filtration in the first filtration device 47 comes up to a reference pressure after long use in the filtration, then the flow of the dope is changed over from the first filtration device 47 to the second filtration device 48 by actuating the valves V1-V6. The filtration is continued by the changeover. After the second filtration device 48 starts the filtration, the first filtration device 47 is subjected to drainage of the dope and washed. Then the first filtration device 47 is subjected to the precoat forming. It is preferable gradually to change the flow rates in the flow lines with an increase and decrease so as to smooth the changeover.

In FIG. 4, the washer 50 includes a washing liquid tank 80, a backwash tank 81, a recovery tank 82, a backwash line 83, a return line 84, plural pumps 78a, 79a, 85 and 92a, a heater 86, a separator 87, and a dryer 88. The backwash line 83 is connected between an outlet of the backwash tank 81 and outlet of the first filtration device 47. The pump 85 and the heater 86 are connected with the backwash line 83. Also, the return line 84 is connected with an inlet of the backwash tank 81 and an inlet of the first filtration device 47. Washing liquid 89 is contained in the washing liquid tank 80. When a valve 80a is opened, the washing liquid 89 of a predetermined amount is supplied to the backwash tank 81. Examples of solvents as the washing liquid 89 are not limited for the purpose of washing the filter 63 of the filtration devices 47 and 48. The solvent for the washing liquid 89 is preferably at least one solvent component included in the solvent components constituting the dope solvent, and desirably all the solvent components constituting the dope solvent.

The heater 86 is constituted by a multi-tube heat exchanger, and applies heat to the washing liquid 89. Temperature of heating of the heater 86 is determined lower by 20 deg. C. than a boiling point of the washing liquid 89 under the atmospheric pressure in a condition of no boiling of the washing liquid 89. It is possible to raise efficiency in washing the first filtration device 47 by heating the washing liquid 89 for use therein.

The washing liquid 89 supplied to the first filtration device 47 through the backwash line 83 passes the filter 63 in a direction back to the polymer dope 41 in the filtration, and is returned to the backwash tank 81 through the return line 84. Thus, the washing liquid 89 flows in the first filtration device 47 in circulation, to strip the deposit layer 62 from the filter screen 60. Slurry 90 is created by dispersion of the deposit layer 62 as filter cake in the washing liquid 89 after removal from the filter screen 60, and flows out of the first filtration device 47 to return to the backwash tank 81. A turbidity meter 84a measures turbidity of the slurry 90. When the turbidity increases and comes up to a target value, then the entirety or part of the fluid in the backwash tank 81 is dispensed to the recovery tank 82 through a drain line 78 and the pump 78a. After removal of the slurry 90 to the recovery tank 82, the washing liquid 89 is supplied to the backwash tank 81 from the washing liquid tank 80. At the lapse of a prescribed washing time and when the turbidity of the slurry 90 becomes equal to or lower than a limit level, then the circulation of the washing liquid 89 is stopped. After this, the washing liquid 89 is drained from the first filtration device 47. The drainage can be rapid and reliable, because the solvent saturated gas 76 of the washing liquid, gaseous nitrogen and the like are supplied to and filled in the first filtration device 47.

A circulation line 93 extends from the recovery tank 82 for flow of the slurry 90 to the separator 87. The separator 87 separates the slurry 90 into residue 90a and solution 90b. A viscometer 79b and the pump 79a reside in a circulation line 79 between the recovery tank 82 and the backwash tank 81.

The viscometer 79b constantly measures the viscosity of the slurry 90 after recovery. The washing liquid 89 is supplied to the backwash tank 81 to keep the viscosity of the slurry 90 in a predetermined range according to the measured viscosity from the viscometer 79b. The viscosity of the slurry 90 is controlled and set equal to or lower than 200 mPa·s before supply of the slurry 90 to the separator 87. The control of the viscosity equal to or lower than 200 mPa·s makes it possible to recover the slurry 90 in a separate manner with an ensured flow rate. Note that if the viscosity of the slurry 90 is higher than 200 mPa·s, the efficiency in operation of the separator 87 will be low due to the excessively high viscosity.

Strainers 95 are used in the separator 87, and have a form of tube constituted by 350 mesh of the SUS steel. The strainers 95 separate the slurry 90 into the residue 90a and the solution 90b. The residue 90a or solid content can operate as filter aid in the separator 87, so that the separation of the solution 90b from the residue 90a can be ensured. Note that the separation is not effectively carried out immediately after the start of the separating step, due to lack of a precoat with the residue 90a. In view of this, a circulation line 92 is used between the separator 87 and the recovery tank 82 together with the circulation line 93 at the time of starting the separation, to circulate the slurry 90. A valve 92b and the pump 92a reside in the circulation line 92. A valve 93b resides in the circulation line 93. When a precoat is formed by circulation of the slurry 90 in the manner similar to FIG. 2, effect of separation can be obtained. The valve 93b is actuated to change over to the separation from the circulation, so a solution recovery tank 94 is supplied with the solution 90b after the separation. The solution 90b can be reused for preparing the dope and washing.

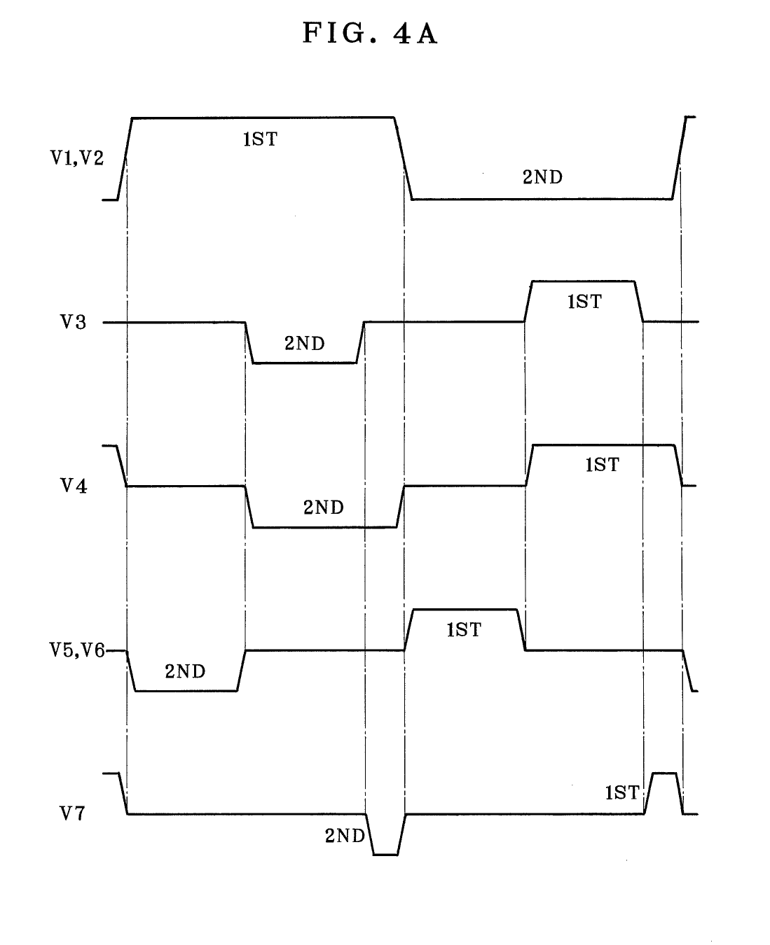

A pressure meter 96 is associated with the separator 87, and detects the pressure of the filtration. When the filtration pressure is found to come up to a target pressure, then the separation is terminated as the thickness of the filter is found too great in view of a tolerable range for reliable filtration. Then the strainers 95 are removed from a separator case 87a. The residue 90a is dried by the dryer 88 of FIG. 5.

The dryer 88 includes a drying chamber 120, a solvent gas recovery device 121, and an evaporative gas circulator 122. A plurality of the strainers 95 are arranged in the drying chamber 120. Evaporative gas 123 is caused by the evaporative gas circulator 122 to flow in the drying chamber 120. The evaporative gas 123 dries the solution 90b from the residue 90a, and also burns the impurity 64 or filter cake. Note that a drying method may be different from the circulation of the evaporative gas 123, for example, may be direct heating with a heater, burner or other heating device.

The evaporative gas 123 for drying contains solvent gas. The evaporative gas 123 is withdrawn by the solvent gas recovery device 121 at one time, and processed for removal of the solvent 21. The evaporative gas 123 after the removal of the solvent 21 is heated by a heater in the evaporative gas circulator 122 at a predetermined temperature, and then supplied into the drying chamber 120 in a dry state. The residue 90a after the drying is reused as filter aid. Note that the residue 90a may be used itself without change, and also can be used as a mixture with an unused component of the filter aid 44 at a suitable ratio.

To supply the separator 87 with the slurry 90 from the recovery tank 82, the pump 79a is used. Furthermore, the slurry 90 can be supplied by other methods, for example pressure method for flow by a pressure device with pressure of N₂ gas, and a method of drainage with the weight under gravity. The density of the slurry 90 is preferably equal to or more than 0.15 wt. % and equal to or lower than 25 wt. % for the purpose of keeping smooth the flow of the slurry 90. Note that the density of the slurry 90 is a ratio of an amount of the residue 90a in the slurry 90. Should the slurry 90 have the density more than 25 wt. %, it is difficult to cause the slurry 90 to flow typically according to its weight under gravity.

After the washing, the filter regenerating device 49 operates for filter regeneration of the first filtration device 47 by circulation. The precoat 62a is formed on the filter screen 60 as illustrated in FIG. 2. Note that the washing and filter regenerating steps for the second filtration device 48 are the same as those for the first filtration device 47, which is illustrated in FIG. 4A.

In the washer 50 of the embodiment, the backwash tank 81, the recovery tank 82 and the separator 87 are used. However, the recovery tank 82 may not be used. The separator 87 can be used for recovery and separation of the slurry 90 in place of the recovery tank 82.

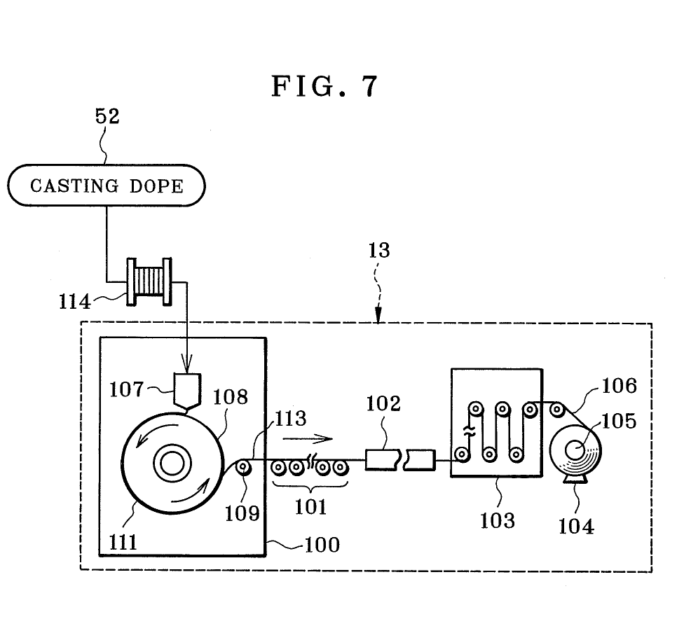

In FIG. 7, the solution casting subsystem 13 includes a casting chamber 100, a transition region 101, a tentering machine 102, a dryer with a drying chamber 103, and a winder 104. Polymer film 106 is formed by the solution casting subsystem 13 from the casting dope 52. In the casting chamber 100 are disposed a casting die 107, a casting drum 108 as casting support, and a stripping roller 109. The casting die 107 causes the casting dope 52 to flow out for casting.

The casting dope 52 after removal of impurity is cast by the casting die 107 on to the casting drum 108 rotating endlessly. So cast film 111 is formed. A surface temperature of the casting drum 108 is preferably at a constant level in a range equal to or higher than −10 deg. C. and equal to or lower than 10 deg. C. Casting the dope on the casting drum 108 thus conditioned results in forming the cast film 111 of a gel form in a short time owing to rapid cooling. Gelling of the cast film 111 proceeds in the course of rotation of the casting drum 108. A self-supporting cast film 113 is separated from the casting drum 108 by stripping of the cast film 111 with the stripping roller 109.

In the transition region 101, the self-supporting cast film 113 is supported by numerous rollers, and dried while transported. In the tentering machine 102, web edges of the self-supporting cast film 113 are retained by pins or other retaining mechanisms. The self-supporting cast film 113 is dried to obtain the polymer film 106. The polymer film 106 is wound by a spindle 105 of the winder 104 in a roll form.

A final filtration device 114 is positioned upstream from the casting die 107, and filters the casting dope shortly before the casting. Impurity of the very small size in the casting dope is removed by the filtration. In the embodiment, the final filtration device 114 includes a filter of metal. However, the final filtration device 114 can have any suitable structure, for example, with filter paper. An average pore diameter of the final filtration device 114 is preferably 100 microns or less for the purpose of removing fine impurity. Should the average pore diameter be too small, the efficiency in the filtration will be low according to long time for the filtration. Should the average pore diameter be too great, fine impurity is difficult to capture in the casting dope 52. It is possible to construct the final filtration device 114 in view of productivity and various requirements.

Various methods suggested in JP-A 2005-104148 are usable in combination with the casting of the invention, the methods including construction of the casting die, decompression chamber, support and other mechanical elements, multi casting, stripping, stretching, conditioning for drying in respective steps, polymer film handling, winding after eliminating a curl for flatness, solvent collection, and polymer film collection. Those can be used in the present invention.

A. Support of Metal for Solution Casting

Suggested in JP A 2000-84960; U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, GB A 640731 (corresponding to U.S. Pat. No. 2,492,977), GB A 735892; JP B 45-4554, JP B 49-5614, JP A 60-176834, JP A 60-203430, and JP A 62-115035.

B. Multi Casting

Suggested in JP B 62-43846; JP A 61-158414, JP A 1-122419, JP B 60-27562, JP A 61-94724, JP A 61-947245, JP A 61-104813, JP A 61-158413, JP A 6-134933; JP A 56-162617; JP A 61-94724, JP A 61-94725, and JP A 11-198285.

C. Specific Methods of Casting of Cellulose Esters

Suggested in JP A 61-94724, JP A 61-148013, JP A 4-85011 (corresponding to U.S. Pat. No. 5,188,788), JP A 4-286611, JP A 5-185443, JP A 5-185445, JP A 6-278149, and JP A 8-207210.

D. Stretching

Suggested in JP A 62-115035, JP A 4-152125, JP A 4-284211, JP A 4-298310, and JP A 11-48271.

E. Specific methods of drying

Suggested in JP A 8-134336, JP A 8-259706, and JP A 8-325388.

F. Drying of Specific Controls of Heat

Suggested in JP A 04-001009 (corresponding to U.S. Pat. No. 5,152,947), JP A 62-046626, JP A 04-286611, and JP A 2000-002809.

G. Drying in Preventing Wrinkles

Suggested in JP A 11-123732, JP A 11-138568, and JP A 2000-176950.

The polymer film obtained according to the invention has high transparency and high retardation value, and has low dependency upon humidity. Thus, the polymer film can be used as phase difference film for a polarizer plate, and also as protection film for protecting a surface of the polarizer plate. Various uses of the cellulose ester film of the invention are disclosed with examples of liquid crystal display panels in JP-A 2005-104148, including TN type, STN type, VA type, OCB type, reflection type and the like. Any of those can be used in the present invention.

No. 1. Cellulose Ester Protective Films for Polarizers

Suggested in JP A 10-095861, JP A 10-095862, and JP A 09-113727.

No. 2. Uses of Cellulose Ester Films as High Performance Optical Elements

Suggested in JP A 2000-284124, JP A 2000-284123, and JP A 11-254466.

No. 3. Production of Cellulose Ester Films as High Performance Optical Elements

Suggested in JP A 2000-131523, JP A 06-130226, JP A 06-235819, JP A 2000-212298 (corresponding to U.S. Pat. No. 6,731,357), and JP A 2000-204173.

No. 4. Optical Compensation Sheets

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 5. TN Type of LCD Panels

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 6. Reflection Type of LCD Panels

Suggested in JP A 10-123478, WO 9848320 (corresponding to U.S. Pat. No. 6,791,640), JP B 3022477 (corresponding to U.S. Pat. No. 6,433,845); and WO 00-65384 (corresponding to EP A 1182470).

No. 7. Discotic Compounds as Coating Cellulose Ester Films

Suggested in JP A 7-267902, JP A 7-281028 (corresponding to U.S. Pat. No. 5,518,783), and JP A 7-306317.

No. 8. Characteristics of Optical Compensation Sheets

Suggested in JP A 8-5837, JP A 7-191217, JP A 8-50206, and JP A 7-281028.

No. 9. Production of Optical Compensation Sheets

Suggested in JP A 9-73081, JP A 8-160431, and JP A 9-73016.

No. 10. Use of Cellulose Ester Films in LCD Panels

Suggested in JP A 8-95034, JP A 9-197397, and JP A 11-316378.

No. 11. LCD Elements of Guest-Host Reflection Types

Suggested in JP A 6-222350, JP A 8-36174, JP A 10-268300, JP A 10-292175, JP A 10-293301, JP A 10-311976, JP A 10-319442, JP A 10-325953, JP A 10-333138, and JP A 11-38410.

No. 12. Coating Methods

Suggested in U.S. Pat. No. 2,681,294; U.S. Pat. No. 2,761,791, U.S. Pat. No. 2,941,898, U.S. Pat. No. 3,508,947, and U.S. Pat. No. 3,526,528.

No. 13. Constructions of Overlaying Coatings

Suggested in JP A 8-122504, JP A 8-110401, JP A 10-300902 (corresponding to U.S. Pat. No. 6,207,263), JP A 2000-111706; JP A 10-206603 (corresponding to U.S. Pat. No. 6,207,263), and JP A 2002-243906.

No. 14. High Refractive Index Layer and Middle Refractive Index Layer

Suggested in JP A 11-295503, JP A 11-153703 (corresponding to U.S. Pat. No. 6,210,858), JP A 2000-9908, JP A 2001-310432, JP A 2001-166104 (corresponding to U.S. Pat. No. 6,791,649), U.S. Pat. No. 6,210,858, JP A 2002-277609 (corresponding to U.S. Pat. No. 6,949,284), JP A 2000-47004, JP A 2001-315242, JP A 2001-31871, JP A 2001-296401, and JP A 2001-293818.

No. 15. Low Refractive Index Layer

Suggested in JP A 9-222503, JP A 11-38202, JP A 2001-40284, JP A 2000-284102, JP A 11-258403, JP A 58-142958, JP A 58-147483, JP A 58-147484, JP A 9-157582 (corresponding to U.S. Pat. No. 6,183,872), JP A 11-106704 (corresponding to U.S. Pat. No. 6,129,980), JP A 2000-117902, JP A 2001-48590 (corresponding to U.S. Pat. No. 6,511,721), and JP A 2002-53804 (corresponding to U.S. Pat. No. 6,558,804).

No. 16. Hard Coat Layer

Suggested in JP A 2002-144913, JP A 2000-9908, and WO 00/46617 (corresponding to U.S. Pat. No. 7,063,872).

No. 17. Front Scattering Layer

Suggested in JP A 11-38208, JP A 2000-199809 (corresponding to U.S. Pat. No. 6,348,960), and JP A 2002-107512.

No. 18. Antiglare Characteristic

Suggested in Japanese Patent Application 2000-271878 (corresponding to JP A 2002-082207); JP A 2001-281410, Japanese Patent Application 2000-95893 (corresponding to U.S. Pat. No. 6,778,240), JP A 2001-100004 (corresponding to U.S. Pat. No. 6,693,746), JP A 2001-281407; JP A 63-278839, JP A 11-183710, and JP A 2000-275401.

No. 19. Dichroic Compounds

Suggested in JP A 1-161202, JP A 1-172906, JP A 1-172907, JP A 1-183602, JP A 1-248105, JP A 1-265205, and JP A 7-261024 (corresponding to U.S. Pat. No. 5,706,131).

No. 20. Various Devices and Films for Optics

Suggested in JP A 5-19115, JP A 5-119216, JP A 5-162261, JP A 5-182518, JP A 5-196819, JP A 5-264811, JP A 5-281411, JP A 5-281417, JP A 5-281537, JP A 5-288921, JP A 5-288923, JP A 5-311119, JP A 5-339395, JP A 5-40204, JP A 5-45512, JP A 6-109922, JP A 6-123805, JP A 6-160626, JP A 6-214107, JP A 6-214108, JP A 6-214109, JP A 6-222209, JP A 6-222353, JP A 6-234175, JP A 6-235810, JP A 6-241397, JP A 6-258520, JP A 6-264030, JP A 6-305270, JP A 6-331826, JP A 6-347641, JP A 6-75110, JP A 6-75111, JP A 6-82779, JP A 6-93133, JP A 7-104126, JP A 7-134212, JP A 7-181322, JP A 7-188383, JP A 7-230086, JP A 7-290652, JP A 7-294903, JP A 7-294904, JP A 7-294905, JP A 7-325219, JP A 7-56014, JP A 7-56017, JP A 7-92321, JP A 8-122525, JP A 8-146220, JP A 8-171016, JP A 8-188661, JP A 8-21999, JP A 8-240712, JP A 8-25575, JP A 8-286179, JP A 8-292322, JP A 8-297211, JP A 8-304624, JP A 8-313881, JP A 8-43812, JP A 8-62419, JP A 8-62422, JP A 8-76112, JP A 8-94834, JP A 9-137143, JP A 9-197127, JP A 9-251110, JP A 9-258023, JP A 9-269413, JP A 9-269414, JP A 9-281483, JP A 9-288212, JP A 9-288213, JP A 9-292525, JP A 9-292526, JP A 9-294959, JP A 9-318817, JP A 9-80233, JP A 9-99515, JP A 10-10320, JP A 10-104428, JP A 10-111403, JP A 10-111507, JP A 10-123302, JP A 10-123322, JP A 10-123323, JP A 10-176118, JP A 10-186133, JP A 10-264322, JP A 10-268133, JP A 10-268134, JP A 10-319408, JP A 10-332933, JP A 10-39137, JP A 10-39140, JP A 10-68821, JP A 10-68824, JP A 10-90517, JP A 11-116903, JP A 11-181131, JP A 11-211901, JP A 11-211914, JP A 11-242119, JP A 11-246693, JP A 11-246694, JP A 11-256117, JP A 11-258425, JP A 11-263861, JP A 11-287902, JP A 11-295525, JP A 11-295527, JP A 11-302423, JP A 11-309830, JP A 11-323552, JP A 11-335641, JP A 11-344700, JP A 11-349947, JP A 11-95011, JP A 11-95030, JP A 11-95208, JP A 2000-109780, JP A 2000-110070, JP A 2000-119657, JP A 2000-141556, JP A 2000-147208, JP A 2000-17099, JP A 2000-171603, JP A 2000-171618, JP A 2000-180615, JP A 2000-187102, JP A 2000-187106, JP A 2000-191819, JP A 2000-191821, JP A 2000-193804, JP A 2000-204189, JP A 2000-206306, JP A 2000-214323, JP A 2000-214329, JP A 2000-230159, JP A 2000-235107, JP A 2000-241626, JP A 2000-250038, JP A 2000-267095, JP A 2000-284122, JP A 2000-292780, JP A 2000-292781, JP A 2000-304927, JP A 2000-304928, JP A 2000-304929, JP A 2000-309195, JP A 2000-309196, JP A 2000-309198, JP A 2000-309642, JP A 2000-310704, JP A 2000-310708, JP A 2000-310709, JP A 2000-310710, JP A 2000-310711, JP A 2000-310712, JP A 2000-310713, JP A 2000-310714, JP A 2000-310715, JP A 2000-310716, JP A 2000-310717, JP A 2000-321560, JP A 2000-321567, JP A 2000-329936, JP A 2000-329941, JP A 2000-338309, JP A 2000-338329, JP A 2000-344905, JP A 2000-347016, JP A 2000-347017, JP A 2000-347026, JP A 2000-347027, JP A 2000-347029, JP A 2000-347030, JP A 2000-347031, JP A 2000-347032, JP A 2000-347033, JP A 2000-347034, JP A 2000-347035, JP A 2000-347037, JP A 2000-347038, JP A 2000-86989, and JP A 2000-98392; and

JP A 2001-4819, JP A 2001-4829, JP A 2001-4830, JP A 2001-4831, JP A 2001-4832, JP A 2001-4834, JP A 2001-4835, JP A 2001-4836, JP A 2001-4838, JP A 2001-4839, JP A 2001-100012, JP A 2001-108805, JP A 2001-108806, JP A 2001-133627, JP A 2001-133628, JP A 2001-142062, JP A 2001-142072, JP A 2001-174630, JP A 2001-174634, JP A 2001-174637, JP A 2001-179902, JP A 2001-183526, JP A 2001-183653, JP A 2001-188103, JP A 2001-188124, JP A 2001-188125, JP A 2001-188225, JP A 2001-188231, JP A 2001-194505, JP A 2001-228311, JP A 2001-228333, JP A 2001-242461, JP A 2001-242546, JP A 2001-247834, JP A 2001-26061, JP A 2001-264517, JP A 2001-272535, JP A 2001-278924, JP A 2001-2797, JP A 2001-287308, JP A 2001-305345, JP A 2001-311823, JP A 2001-311827, JP A 2001-350005, JP A 2001-356207, JP A 2001-356213, JP A 2001-42122, JP A 2001-42323, JP A 2001-42325, JP A 2001-51118, JP A 2001-51119, JP A 2001-51120, JP A 2001-51273, JP A 2001-51274, JP A 2001-55573, JP A 2001-66431, JP A 2001-66597, JP A 2001-74920, JP A 2001-81469, JP A 2001-83329, JP A 2001-83515, JP A 2001-91719, JP A 2002-162628, JP A 2002-169024 (corresponding to U.S. Pat. No. 6,606,136), JP A 2002-189421, JP A 2002-201367 (corresponding to U.S. Pat. No. 6,093,133), JP A 2002-20410 (corresponding to U.S. Pat. No. 6,974,608), JP A 2002-258046, JP A 2002-275391, JP A 2002-294174, JP A 2002-311214 (corresponding to U.S. Pat. No. 6,841,237), JP A 2002-311246 (corresponding to U.S. Pat. No. 6,965,473), JP A 2002-328233, JP A 2002-338703, JP A 2002-363266 (corresponding to U.S. Pat. No. 6,894,141), JP A 2002-365164, JP A 2002-370303, JP A 2002-40209 (corresponding to U.S. Pat. No. 6,649,271), JP A 2002-48917 (corresponding to U.S. Pat. No. 6,628,369), JP A 2002-6109 (corresponding to U.S. Pat. No. 6,505,942), JP A 2002-71950, JP A 2002-82222, JP A 2002-90528, JP A 2003-105540 (corresponding to U.S. Pat. No. 6,689,479), JP A 2003-114331, JP A 2003-131036 (corresponding to U.S.P. 2003/031848), JP A 2003-139952, JP A 2003-153353, JP A 2003-172819, JP A 2003-35819, JP A 2003-43252 (corresponding to U.S. Pat. No. 6,552,145), JP A 2003-50318 (corresponding to U.S. Pat. No. 7,136,225), and JP A 2003-96066 (corresponding to U.S. Pat. No. 7,087,273).

Examples of the invention are described together with various comparative examples. Note that the invention is not limited to those examples.

### EXAMPLE 1

The polymer dope 41 was prepared by use of the components listed below. The solvent 21 for the polymer dope 41 was mixed solvent containing dichloromethane, methanol and 1-butanol.

[Components for the dope]

| | | |
|---|---|---|
| Cellulose triacetate | 100 | parts by weight |
| Dichloromethane | 320 | parts by weight |
| Methanol | 83 | parts by weight |
| 1-butanol | 3 | parts by weight |
| Plasticizer A | 7.6 | parts by weight |
| Plasticizer B | 3.8 | parts by weight |
| UV absorber a | 0.7 | part by weight |
| UV absorber b | 0.3 | part by weight |
| Mixture of citrate esters | 0.006 | part by weight |
| Fine particles | 0.05 | part by weight |

In the list, the cellulose triacetate was powder particles having the following specifics—substitution degree: 2.84, viscosity average degree of polymerization (DP): 306, water content: 0.2 wt. %, viscosity of 6 wt. % dichloromethane solution: 315 mPa·s, average particle diameter of powder particles: 1.5 mm, standard deviation of the particle diameter of powder particles: 0.5 mm. The plasticizer A was triphenylphosphate. The plasticizer B was diphenylphosphate. The UV absorber a was 2(2′-hydroxy-3′,5′-di-tert-butylphenyl)benzotriazol. The UV absorber b was 2(2′-hydroxy-3′,5′-di-tert-amylphenyl) 5-chlorobenzotriazol. The citrate ester compound was mixture of citrate esters (mixture of citric acid, citrate monoethyl ester, citrate diethyl ester, and citrate triethyl ester). The fine particles were particles of silicon dioxide with a particle diameter of 15 nm, and Mohs hardness number of approx. 7. In the preparation of the dope, 4.0 wt. % of retardation control agent N—N-di-m-toluoyl-N—P-methoxy phenyl-1,3,5-triazine-2,4,6-triamine was added at the amount relative to the total weight of the polymer film.

The first filtration device 47 in the filtration subsystem 12 filtered the polymer dope 41 in the solution casting system 10 of FIG. 1. The filter aid in the first filtration device 47 was particles of diatomaceous earth with an average diameter of 35 microns. Before filtration of the polymer dope 41, the first filtration device 47 had been subjected to forming of the precoat by the filter regeneration. After the precoat forming, the precoat solution was drained.

For precoat solution, components were supplied in a precoat solution tank, including particles of diatomaceous earth with an average diameter of 35 microns as filter aid, dope containing 20 wt. % of cellulose triacetate, and solvent for dilution. The precoat solution was prepared to have filter aid density of 3.0 wt. % and cellulose density of 3.5 wt. %. The prepared precoat solution was contained in the circulating reservoir 66. The precoat solution was circulated at a flow rate of 20 liters per minute per sq. meter between the first filtration device 47 and the circulating reservoir 66. A precoat was formed on the filter screen 60 in the first filtration device 47. The filter screen 60 was 350 mesh of the SUS steel.

An electronic sensor F71RAN manufactured by Takenaka Electronic Industrial Co., Ltd. was used as each of the turbidity meters 69a and 69b to detect the density of the filter aid according to their output. The turbidity meter 69b resided in the drain line 73 of the first filtration device 47. The measured level of the turbidity meter 69b became 0 wt. % at the lapse of 3 minutes from the start of the circulation. The measured level of the turbidity meter 69a on the communication flow line 74 of the first filtration device 47 decreased gradually from 2.0 wt. % as initial level at the start of the circulation, and became 0 wt. % at the lapse of 30 minutes. Then the layer growth of the precoat was detected sufficient. Note that the total of the filter aid of the precoat in the circulation was obtained according to the total of the filter aid sufficient for obtaining predetermined strength. In the embodiment, the amount of the filter aid was 37.5 kg per sq. meter (per unit area of filtration). The amount of the filter aid was so high as to obtain an average thickness of 3 mm for the total area of the filtration of the filter screen.

The terminal settling velocity of the filter aid during the precoat forming was 10⁻³ cm/sec. To measure the terminal settling velocity was based upon measurement of a distance of moving in the settling and the Navier-Stokes Equations. Time required for forming the precoat 62a was one (1) hour.

After the precoat 62a was formed, the precoat solution 61 was drained by its own weight from the first filtration device 47. The valve V7 of the gas flow line 75 was opened to connect the first filtration device 47 with the circulating reservoir 66. At the same time as the drainage, the solvent saturated gas 76 was filled in the first filtration device 47 at an amount of a drained part of the precoat solution 61. Therefore, no skin layer was formed on the precoat 62a because of the feature of the invention distinct from the known structure in which the precoat 62a is forcibly drained by pressure of dry air, dry gaseous nitrogen or the like. Also, the open area of the valve V7 of the gas flow line 75 was adjusted so that it was possible to set the draining speed of the precoat solution 61 equal to or lower than 1×10⁻³ m/s relative to the surface of the precoat layer. The precoat 62a without fine gap was obtained by setting the draining speed of the precoat solution 61 equal to or lower than 1×10⁻³ m/s. The first filtration device 47 was opened to observe the filter visually. As a result, the precoat 62a with a predetermined thickness was found to exist. After this, the filter regeneration was repeated in the same condition. The same result was obtained.

### COMPARATIVE EXAMPLE 1

Example 1 was repeated with a difference of the flow rate of the precoat solution equal to 3.0 liters/(m²·min). After the start of filtration with the dope solution, there occurred initial drop of filter cake. Time required for obtaining the clarified solution of filtrate was three times as long as that according of Example 1.

### COMPARATIVE EXAMPLE 2

Example 1 was repeated with a difference of the flow rate of the precoat solution equal to 80 liters/(m²·min). As a result, remarkable drop of the filter aid occurred. No precoat was formed as no filter aid was deposited on the filter screen.

### COMPARATIVE EXAMPLE 3

Example 1 was repeated with a difference in that the density of cellulose in the precoat solution was 5.0 wt. %. A loss in the pressure was considerable according to the high viscosity. A flow rate of the precoat solution in the circulation was set 1 liter/(m²·min). As a result, 24 hours were taken for forming the precoat 62a.

### COMPARATIVE EXAMPLE 4

Example 1 was repeated with a difference in that particles of diatomaceous earth had an average diameter of 90 microns, viscosity of the precoat solution was 0.4 mPa·s, and terminal settling velocity of the filter aid was 1.1 cm/sec. As a result of filter regeneration, no precoat in a uniform shape was obtained.

### COMPARATIVE EXAMPLE 5

Example 1 was repeated with a difference in that the viscosity of the precoat solution was 210 mPa·s and the terminal settling velocity was 2×10⁴ cm/sec in the precoat forming. As a result, a loss in the pressure was considerable so that a flow rate of the precoat solution in the circulation was as small as 3.0 liters/(m²·min). Eight (8) hours were taken for forming the precoat 62a.

### COMPARATIVE EXAMPLE 6

Example 1 was repeated inclusive of a step of forming the precoat 62a, with a difference of sending gaseous nitrogen into the first filtration device 47 for drainage of liquid after forming the precoat 62a. As a result, slug formation occurred on the surface of the precoat 62a after the drainage. The loss of the pressure was so great that the filtration was impossible.

### COMPARATIVE EXAMPLE 7

Example 1 was repeated with a difference in that the speed of drainage with the weight was set 2×10⁻³ m/s by adjusting the open area of the valve. As a result, a precoat growing as deposit flowed away due to the high speed of the drainage with the weight. No precoat was formed in a firmly attached form.

In conclusion, it is possible efficiently to form a precoat without fine gap when viscosity of the precoat solution is 0.5-200 mPa·s, a flow rate of the precoat solution is 3.3-80 liters/(m²·min), and terminal settling velocity of the filter aid is in a range of 10⁻⁴ to 1 cm/sec.

A flow rate of drainage of the precoat solution is set equal to or lower than 1×10⁻³ m/s relative to the surface of the precoat layer, so that forming of the precoat can be continued. Solvent saturated gas is filled in the filtration device in compliance with the drainage, so that occurrence of slug formation or skinning as incrustation on the surface of the precoat can be prevented. A precoat with high performance of filtration can be formed.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A solution casting process of casting polymer dope containing polymer and solvent to form polymer film continuously, comprising:
a filtering step of filtering said polymer dope to be cast in a filtration device having a precoat of a filter aid deposited on a filter screen;
a washing step of washing said filtration device after discontinuing supply of said polymer dope to said filtration device;
a filter regenerating step of depositing a precoat of said filter aid in said washed filtration device by use of precoat solution containing said filter aid, said polymer dope and solvent;
a draining step of draining said precoat solution from said filtration device after depositing said precoat, wherein said filtration device is charged with solvent gas upon draining; and
a changeover step of changing over plural filtration devices, to subject said filtration device among said filtration devices to said washing step, said filter regenerating step and said draining step.

2. A solution casting process as defined in claim 1, wherein in said washing step, washing is carried out after said filter aid is drained in a form of slurry.

3. A solution casting process as defined in claim 1, wherein in said changeover step, efficiency information of filtration of said filtration device is monitored, and when said efficiency information becomes lower than reference efficiency information, said filtration device is washed in said washing step.

4. A solution casting process as defined in claim 1, wherein viscosity of said precoat solution is 0.5-200 mPa·s.

5. A solution casting process as defined in claim 1, wherein in said filter regenerating step, a terminal settling velocity of said filter aid is controlled in a range of 10⁻⁴ to 1 cm/sec.

6. A solution casting process as defined in claim 5, wherein in said filter regenerating step, a flow rate of said precoat solution relative to said filter screen is 3.3-80 liters/(m²·min).

7. A solution casting process as defined in claim 5, wherein a flow rate of draining said precoat solution in said draining step is 1×10⁻³ m/sec or less relative to a surface of said precoat.

8. A solution casting process as defined in claim 7, wherein said filter aid is silicon dioxide with an average particle diameter in a range of 20-50 microns, said polymer is cellulose acylate, density of said filter aid in said precoat solution is 0.25-5.0 wt. %, and density of cellulose in said precoat solution is 0.5-5.0 wt. %.

9. A solution casting process as defined in claim 1, wherein said plural filtration devices are connected in parallel, and in said changeover step, said filtration devices are cyclically changed over to continue said filtering step.

10. A solution casting apparatus for casting polymer dope containing polymer and solvent to form polymer film continuously, comprising:
a filtration device, having a precoat of a filter aid deposited on a filter screen, for filtering said polymer dope to be cast;
a washer for washing said filtration device after discontinuing supply of said polymer dope to said filtration device;
a filter regenerating device for depositing a precoat of said filter aid in said washed filtration device by use of precoat solution containing said filter aid, said polymer dope and solvent;
a drain line for draining said precoat solution from said filtration device after depositing said precoat, wherein said filtration device is charged with solvent gas upon draining; and
a valve mechanism for changing over plural filtration devices, to manage said filtration device among said filtration devices with said washer, said filter regenerating device and said drain line.

11. A solution casting apparatus as defined in claim 10, wherein said washer washes after said filter aid is drained in a form of slurry.

12. A solution casting apparatus as defined in claim 10, further comprising a controller for monitoring efficiency information of filtration of said filtration device, and for, when said efficiency information becomes lower than reference efficiency information, actuating said valve mechanism to wash said filtration device with said washer.

13. A solution casting apparatus as defined in claim 12, wherein said controller monitors filtration pressure of said filtration device, and determines a decrease of said efficiency information according to an increase of said filtration pressure.

14. A solution casting apparatus as defined in claim 12, wherein said filter regenerating device includes a precoat solution reservoir for dispersing said filter aid in a diluted polymer dope obtained by dilution of said polymer dope with said solvent, to obtain said precoat solution.

15. A solution casting apparatus as defined in claim 14, wherein said filter regenerating device includes a circulating reservoir for storing said precoat solution;
said drain line returns said precoat solution to said circulating reservoir from said filtration device;
further comprising a gas flow line for supplying said filtration device with solvent saturated gas of said solvent from said circulating reservoir;
wherein a flow rate of draining said precoat solution in said drain line is 1×10⁻³ m/sec or less relative to a surface of said precoat.

16. A solution casting apparatus as defined in claim 15, wherein said filter aid is silicon dioxide with an average particle diameter in a range of 20-50 microns, said polymer is cellulose acylate, density of said filter aid in said precoat solution is 0.25-5.0 wt. %, and density of cellulose in said precoat solution is 0.5-5.0 wt. %.

17. A solution casting apparatus as defined in claim 10, wherein said plural filtration devices are connected in parallel, and said valve mechanism cyclically changes over said filtration devices to continue filtration.

18. A solution casting apparatus as defined in claim 10, wherein said washer includes:
a washing tank for reserving washing liquid;
a wash line for dispensing said washing liquid to said filtration device to pass said washing liquid through said filtration device;
a return line for dispensing slurry obtained by passage of said washing liquid in said filtration device to said washing tank for circulation; and
a separator for separating said slurry from said washing tank into solution and a solid content.

19. A solution casting apparatus as defined in claim 10, further comprising a polymer dope feeding device for supplying said polymer dope;
wherein said plural filtration devices include first and second filtration devices;
said valve mechanism includes:
a first valve for selectively connecting said first and second filtration devices with said polymer dope feeding device;
a second valve for selectively connecting said first and second filtration devices with said washer;
a third valve for selectively connecting said first and second filtration devices with said filter regenerating device;
a controller for controlling said first, second and third valves, wherein said controller, when said first filtration device is connected with said polymer dope feeding device, connects said second filtration device with said washer at first, and then connects said second filtration device with said filter regenerating device, and when said second filtration device is connected with said polymer dope feeding device, connects said first filtration device with said washer at first, and then connects said first filtration device with said filter regenerating device.
